(19) United States
(12) Patent Application Publication
(10) Pub. No.: US 2009/0100785 A1
(43) Pub. Date: Apr. 23, 2009

(54) INTERIOR WINDOW TRIM KIT

(75) Inventor: James S. Tanner, Woburn, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: HARVEY INDUSTRIES, INC.

(21) Appl. No.: 12/239,113

(22) Filed: Sep. 26, 2008

Related U.S. Application Data
(60) Provisional application No. 60/975,375, filed on Sep. 26, 2007.

(51) Int. Cl. E06B 1/64

(52) U.S. Cl. 52/717.01

(57) ABSTRACT

The present invention is directed towards an interior window trim assembly that can engage with channels found in popularly used window frames. The window trim assembly can provide a pre-assembled, easy-to-install treatment for the jamb and casing surfaces of a window and can provide the same aesthetically and functionally desirable fit and finish as wooden trim crafted on site by expert tradesmen.

### CROSS-REFERENCE TO RELATED APPLICATIONS

The present invention claims priority to U.S. Provisional Application Ser. No. 60/975,375, filed on Sep. 26, 2007 and entitled “Interior Window Trim Kit,” which is hereby incorporated by reference in its entirety.

### TECHNICAL FIELD

The present invention relates generally to construction materials and, in particular, to window trim assemblies.

### BACKGROUND

Conventional methods of installing interior window trim have several disadvantages. For example, traditional wood trim installations require the services of skilled tradesmen because precise woodworking is necessary to measure, cut, and join trim boards to each other and to the window or wall. These traditional installations require the transport of cumbersome tools to and from the job site and can result in wasted materials and lost time spent cleaning up. As a result, this method of installing trim is time consuming and expensive. This method is often used, despite these disadvantages, because the appearance and high-quality fit and finish of expert-crafted wood trim has been a desirable feature for home and building owners.

Other methods and devices for trimming a window do not use wood, but instead use extruded vinyl, aluminum, or plastic trim pieces. These pieces are usually cut to fit on site from lengths of modular extruded stock. The pieces are typically then fastened to the window frame, wall, or jamb surface using a series of clips or mounting brackets. Some of these devices have parts that snap together, slide together, or are screwed or nailed together, for example U.S. Pat. No. 4,250,673 of Hubbard and U.S. Pat. No. 5,941,033 of Adams.

At least one disadvantage of these methods and devices is that the time and skill required to measure and cut the various extruded pieces is almost as burdensome and inefficient as that required for conventional wood trim. Further, the resulting window trim has the appearance of being made from some material other than wood and lacks the professional fit and finish that expert carpenters are able to achieve by constructing custom wood trim with mitered finger joints.

Another disadvantage with these methods and devices for trimming a window is that the snap-fit clips or mounting brackets often used can fail to reliably secure the trim pieces to the wall, or can leave aesthetically undesirable gaps between adjacent surfaces.

Accordingly, there exists a need for window trim assemblies that are easy-to-install, while at the same time providing the aesthetically and functionally desirable fit and finish of expert-crafted wood trim.

### SUMMARY

The present invention is directed towards an interior window trim assembly that can engage with channels found in popularly used window frames. The window trim assembly can provide a pre-assembled, easy-to-install treatment for the jamb and casing surfaces of a window and can provide the same aesthetically and functionally desirable fit and finish as wooden trim crafted on site by expert tradesmen.

In one aspect of the invention, the window trim assembly includes a generally rectangular, prefabricated casing having at least a horizontal wooden top casing element, two or more vertical wooden side casing elements and a set of extension jambs joined to the casing and extending perpendicular thereto, the jambs being adapted to engage a channel formed in a window frame and provide desired spacing between the window frame and the casing such that the casing can lie substantially flat against a finished interior wall.

The trim assembly can further include at least one bottom casing element. In one embodiment, the bottom element can take the form of traditional apron and stool members. In another embodiment, the bottom element can be similar in style to the top and side elements to form a simple “picture frame” type casing.

In another aspect of the invention, the window trim assembly can include a plurality of extension jambs adapted to engage a channel formed in a window frame and provide desired spacing between the window frame and a plurality of casing elements such that the casing elements can lie substantially flat against a finished interior wall.

The present invention provides an interior window trim assembly that can attach to extruded vinyl, aluminum, or other types of window frames. The assembly includes trim elements for both the jamb and casing surfaces of the window area so as to provide a complete interior trim solution. The elements of the trim assembly can be sanded, primed, stained, painted, or cleaned off-site so as to provide a greater ease and efficiency of installation. Alternatively, the elements of the trim assembly can be pre-finished on-site prior to installation.

In another aspect of the invention, at least some of the casing element can be connected by mitered joints, e.g., a mortise and tenon, biscuit, or other suitable joinery to achieve the same appearance and durability as wooden window trim crafted onsite by expert tradesmen.

In another aspect of the invention, the window trim assembly can be designed such that sturdy, easy to install fasteners such as nails, screws, or staples can be used to affix the assembly to the wall or window frame.

Additional objects, advantages, and novel features of the invention will be set forth in part in the description as follows and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The invention will be more fully understood from the following detailed description taken in conjunction with the accompanying drawings, in which:

FIG. 1 is a perspective view of an interior window trim assembly constructed according to an embodiment of the present invention;

FIG. 2 is a front elevational view of a window trimmed using the interior window trim assembly of FIG. 1;

FIG. 3A is a cross sectional view from above of an un-finished window installed in a building wall;

FIG. 3B shows the same cross sectional view as FIG. 3A, only the window of FIG. 3B is finished using the interior window trim assembly of FIG. 1;

FIG. 4A is a perspective view of a mortise and tenon joint that can be used in constructing the interior window trim assembly of FIG. 1;

FIG. 4B is a perspective view of a biscuit joint that can be used in constructing the interior window trim assembly of FIG. 1; and

FIG. 5 is a front elevational view of another exemplary embodiment of the present invention where the trim design is of a simple picture frame type.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

In a typical unfinished window installation, the interior wall surface can have a ragged or rough edge where it meets the perimeter of the rough window opening. These rough edges can be unsightly and typically require some kind of finish treatment. Additionally, absent the installation of finish trim, the unsightly framing member surfaces of the window opening can be left exposed to the interior of the home or building. These surfaces are normally covered by other expensive, inefficient trimming methods. Described herein is an interior window trim assembly that can be used more easily and efficiently to finish such a window installation. The interior window trim assembly can include a casing to cover the rough edges of the interior wall surface and a plurality of extension jambs to mask the framing member surfaces of the window opening.

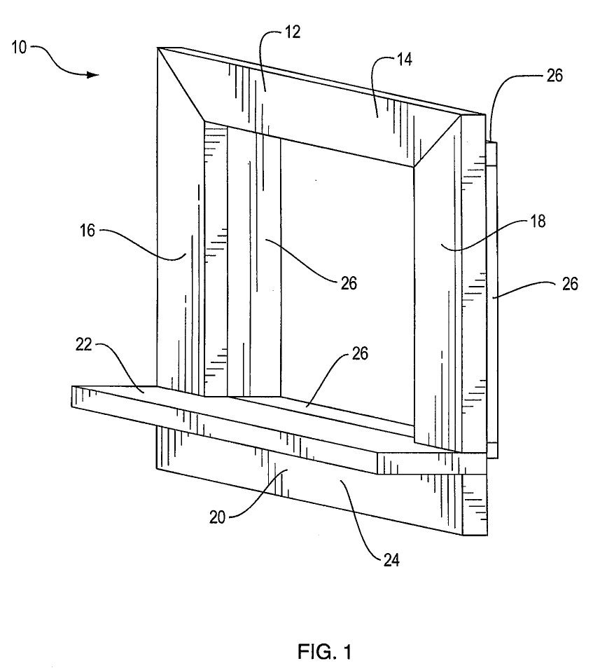

FIG. 1 shows an interior window trim assembly 10. The assembly can include a pre-fabricated casing 12 that can further include a horizontal top casing element 14 and two vertical side casing elements 16, 18. The casing 12 can also include a bottom casing element 20. In one embodiment, the bottom casing element 20 can include a stool member 22 and an apron member 24. In the illustrated embodiment, stool member 22 has a rectangular cross section and extends perpendicularly from the wall surface towards the interior of the home or building. Also in the illustrated embodiment, apron member 24 has a rectangular cross section and is situated beneath stool member 22 such that it lies flat, parallel to the interior wall surface. In one embodiment, the apron member 24 can have mitered or profiled ends or returns. In an exemplary embodiment, the pre-fabricated casing 12 can be of a generally rectangular shape, however in other embodiments it can take other shapes including, but not limited to, circular, hexagonal, half-moon, or oval. A plurality of extension jambs 26 can be joined to the casing 12 and can extend perpendicularly thereto. The extension jambs 26 can be attached to the casing 12 using a variety of known fasteners, including nails, screws, staples, or glue. In the illustrated embodiment, once joined together, the casing 12 and the extension jambs 26 form a generally L-shaped cross section.

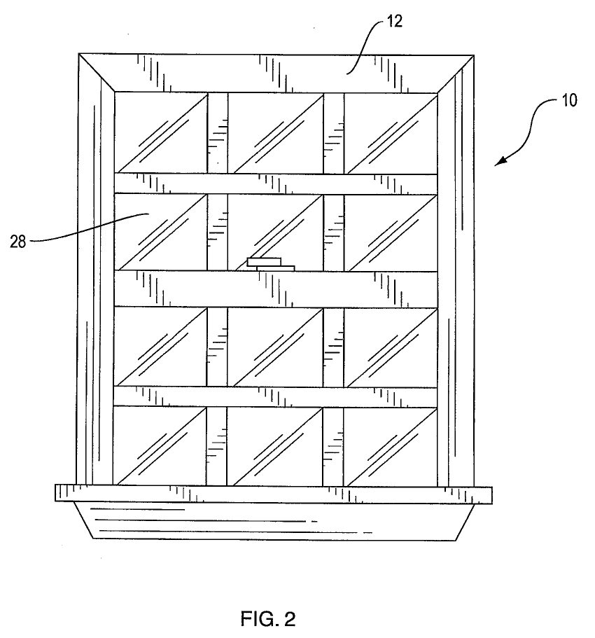

As depicted in FIG. 2, the interior window trim assembly 10 can be installed around a window frame assembly 28. In the illustrated embodiment, pre-fabricated casing 12 surrounds window frame assembly 28 and provides an aesthetically appealing finish treatment for the interior of the home or building.

In an exemplary embodiment, the components of the interior window trim assembly described herein can be custom sized at the factory or some other off-site location, either before being purchased or before being delivered to the user. As an example, extension jambs 26 can be custom sized at the factory to a variety of depths such that the desired spacing between the window frame assembly 28 and the casing 12 can be achieved. In one embodiment, the interior window trim assembly 10 can be custom sized at the factory to fit a variety of popular window sizes and shapes. In other embodiments, the casing 12 can be available in a number of different styles, for example Colonial and Windsor styles. The interior window trim assembly 10 can be constructed from wood in the preferred embodiment, however it can also be made from plastic, vinyl, aluminum, or other suitable material or materials in other embodiments.

The casing 12 and extension jambs 26 can be pre-fabricated and pre-assembled so that, once delivered to a work site, a quick and simple installation can be performed. Further, the interior window trim assembly 10 can be pre-finished either on-site or off-site. Additional finish work can be performed off-site, such as sanding, cleaning, priming, staining, or painting the interior window trim assembly 10. This serves to further reduce the time and skill required to finish a window using the interior window trim assembly described herein. In one embodiment, the interior window trim assembly 10 can be shrink-wrapped using a high-grade film or other durable packaging so as to protect the interior window trim assembly 10 from water, dirt, dust, and handling damage during transport from the factory to the job site.

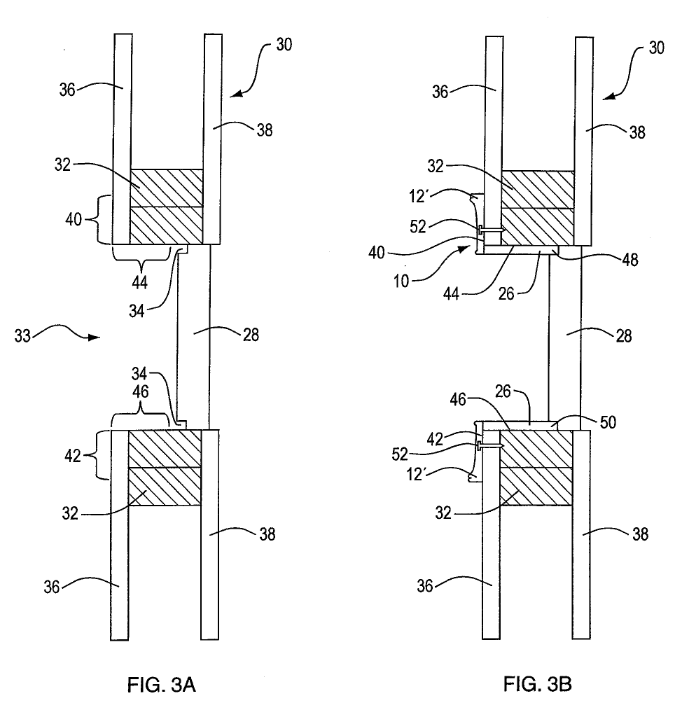

FIG. 3A shows a cross sectional view from above of an un-finished window installation in a building wall 30. Building wall 30 has an interior surface 36 and an exterior surface 38. These surfaces can be constructed from drywall, plaster, brick, wood, aluminum, vinyl, stone, or other material. Window framing members 32 define a rough window opening 33. A window frame assembly 28 can be mounted in the rough window opening 33 by methods known in the art. In the illustrated embodiment, the window frame assembly 28 contains channels 34. The interior surface 36 of building wall 30 can have rough edges 40 and 42 where it meets the rough window opening 33. Further, without some kind of finish treatment, framing member surfaces 44 and 46 can be exposed.

FIG. 3B shows a cross sectional view of the same building wall 30, this time with the interior window trim assembly described herein installed. Extension jambs 26 can provide a finished appearance for the previously exposed framing member surfaces 44 and 46. Likewise, the casing 12 can cover the unfinished edges 40 and 42 of interior wall surface 36. As illustrated, ends 48 and 50 of the extension jambs 26 engage the channels 34 in the window frame assembly 28. A plurality of nails 52 can be used to affix the casing 12 to the interior wall surface 36 or the window framing members 32. Screws, staples, double-sided adhesive members, or other means of fastening can also be employed for this purpose. In other embodiments, the interior window trim assembly 10 can be fastened to the window frame assembly 28, or can be fastened both to the window frame assembly 28 and the window framing members 32.

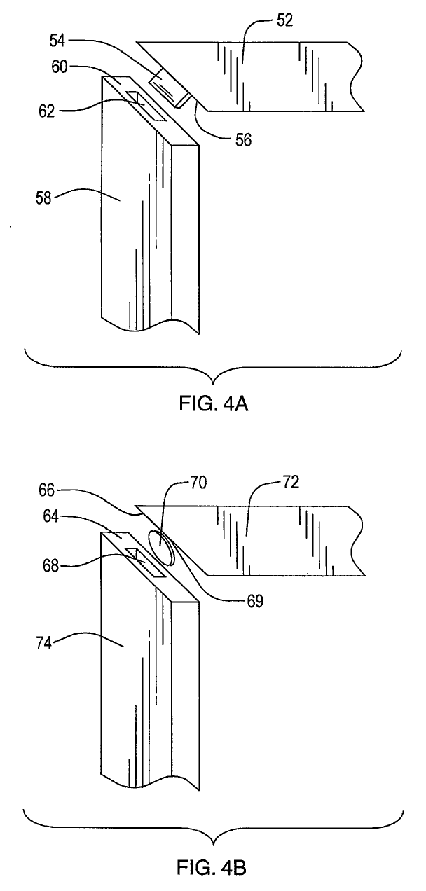

The casing elements of the interior window trim assembly described herein can be mated to each other in a variety of different ways. In an exemplary embodiment, a mitered, mortise and tenon or biscuit style joint is used wherever two casing or trim elements meet. The use of a mortise and tenon joint or biscuit style joint can provide for a stronger joint than simply gluing or otherwise mating two parallel surfaces together. In one embodiment, the casing elements are miter cut at each end to an angle between 0 and 90 degrees. In the illustrated embodiment, the side casing elements 16 and 18 and the top casing element 14 have 45 degree miter cuts at each end. The mitered ends can then be mated using a variety of different methods, for example using a biscuit or mortise and tenon style joint. One benefit of finger joint arrangements like mortise and tenon and biscuit joints is that they resist warping and bending due to moisture, heat, or cold. An additional benefit is that they help provide an expert fit and finish often desired by building and home owners. An example of a mortise and tenon joint is illustrated in FIG. 4A. A first trim element 52 can have a tenon 54, or other male component, extending from a face 56 that can be mated to a second trim element 58. A face 60 of the second trim element 58 can be mated with the face 56 of the first trim element 52, and further, can contain a mortise 62, or other female receptacle. Tenon 54 and mortise 62 are sized such that tenon 54 can be received either partially or wholly within mortise 62. Tenon 54 can be held within mortise 62 by gluing, pinning, wedging, or other methods known in the art.

FIG. 4B illustrates an example of a biscuit joint. Two trim elements 72 and 74 can have faces 64 and 66 that can be mated to each other. Faces 64 and 66 can be machined with slots 68 and 69. A biscuit 70 can then be sandwiched between the two trim elements 72 and 74 such that approximately half of the biscuit 70 protrudes into the slot 69 on the first trim element 72 and the other approximately half of the biscuit 70 protrudes into the slot 68 on the second trim element 74. The biscuit 70 can be constructed of wood, plastic, or any other suitable material. The biscuit 70 can be coated with glue or other adhesive prior to assembly to secure the two trim elements 72 and 74 to each other. In one embodiment, the trim elements 14, 16, 18, and 20 can be joined using biscuit joints.

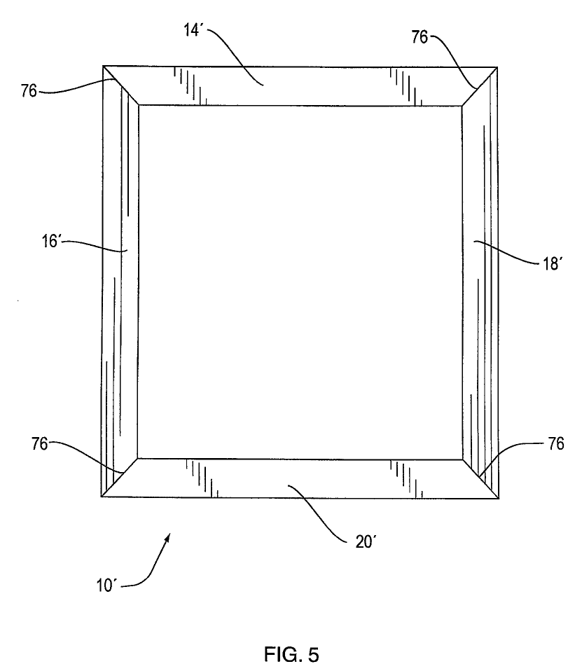

FIG. 5 illustrates a front elevational view of an embodiment in which the interior window trim assembly 10′ has a simple picture frame configuration. In this embodiment, the bottom casing element 20′ is the same or similar to the top casing element 14′, creating a symmetrical appearance. The top casing element 14′ and bottom casing element 20′ are joined to respective ends of the side casing elements 16′, 18′ using mitered joints 76. In exemplary embodiments, mitered joints 76 can be of a mortise and tenon or biscuit style joinery.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. An interior window trim assembly for attachment to a window frame, the assembly comprising:
a generally rectangular, prefabricated casing having at least a horizontal wooden top casing element and a plurality of vertical wooden side casing elements, the casing elements being connected by mitered joints; and
a plurality of extension jambs joined to the casing and extending perpendicular thereto, the jambs being further adapted to engage a channel formed in a window frame and provide desired spacing between the window frame and the casing such that the casing can lie substantially flat against a finished interior wall.

2. An interior window trim assembly according to claim 1, wherein said top casing element and said side casing elements are connected using at least one mortise and tenon joint.

3. An interior window trim assembly according to claim 1, wherein said top casing element and said side casing elements are connected using at least one biscuit joint.

4. An interior window trim assembly according to claim 1, wherein said top casing element and said side casing elements receive an off-site treatment selected from the group consisting of priming, staining, cleaning, painting, and sanding.

5. An interior window trim assembly according to claim 1, wherein said prefabricated casing further comprises at least one bottom casing element.

6. An interior window trim assembly according to claim 5, wherein said prefabricated casing comprises a simple picture frame.

7. An interior window trim assembly according to claim 5, wherein said bottom casing element is constructed of wood.

8. An interior window trim assembly according to claim 5, wherein said bottom casing element receives an off-site treatment selected from the group consisting of priming, staining, cleaning, painting, and sanding.

9. An interior window trim assembly according to claim 5, wherein said bottom casing element and said side casing elements are connected using at least one mortise and tenon joint.

10. An interior window trim assembly according to claim 5, wherein said bottom casing element and said side casing elements are connected using at least one biscuit joint.

11. An interior window trim assembly according to claim 5, wherein said bottom casing element includes stool and apron members.

12. An interior window trim assembly according to claim 11, wherein said stool and apron members are constructed of wood.

13. An interior window trim assembly according to claim 11, wherein said stool and apron members receive an off-site treatment selected from the group consisting of priming, staining, cleaning, painting, and sanding.

14. An interior window trim assembly according to claim 11, wherein said stool member has mitered returns on at least one of its edges.

15. An interior window trim assembly according to claim 11, wherein said stool member has profiled returns on at least one of its edges.
